(19) United States
(12) Patent Application Publication
(10) Pub. No.: US 2026/0003232 A1
(43) Pub. Date: Jan. 1, 2026

(54) DISPLAY PANELS AND DISPLAY DEVICES

(71) Applicant: Guangzhou China Star Optoelectronics Semiconductor Display Technology Co., Ltd., Guangzhou (CN)

(72) Inventors: Lihong GUI, Guangzhou (CN); Jun LI, Guangzhou (CN)

(21) Appl. No.: 18/830,896

(22) Filed: Sep. 11, 2024

Related U.S. Application Data
(63) Continuation of application No. PCT/CN2024/104163, filed on Jul. 8, 2024.

(30) Foreign Application Priority Data
Jun. 27, 2024 (CN) 202410854443.0

(51) Int. Cl. G02F 1/1339; G02F 1/1335; G02F 1/1343; G02F 1/1362; G02F 1/1368

(52) U.S. Cl. CPC G02F 1/1339; G02F 1/133512; G02F 1/134309; G02F 1/136286; G02F 1/1368

(57) ABSTRACT

A display panel and a display device are provided. The display panel includes a plurality of repeating units arranged along a first direction and a second direction and a plurality of spacer structures corresponding to the repeating units. Each of the repeating units includes a first sub-pixel and a second sub-pixel disposed adjacently. A first transistor is disposed in a first non-light-transmitting area of the first sub-pixel, the second sub-pixel includes a second transistor disposed in the first non-light-transmitting area, and the spacer structure is only disposed in the first non-light-transmitting area.

### CROSS-REFERENCE TO RELATED APPLICATION

This application is a continuation of International Application No. PCT/CN2024/104163, filed on Jul. 8, 2024, which claims priority to Chinese Patent Application No. 202410854443.0, filed in the Chinese Patent Office on Jun. 27, 2024, and entitled “Display Panels and Display Devices”, the contents of which are incorporated herein by reference in its entirety.

### TECHNICAL FIELD

The present disclosure relates to display technologies, and in particular to display panels and display devices.

### BACKGROUND

Liquid crystal display (LCD) panels are widely used in various electronic devices such as mobile phones, digital cameras, computer screens or notebook screens.

In the display panel of the related art, each sub-pixel in the display panel is provided with a support pillar and a control transistor, which occupy the area of the light-transmitting area in the sub-pixel and reduce the aperture ratio of the sub-pixel.

### SUMMARY

The present disclosure provides a display panel and a display device to improve the problem that the sub-pixel in existing display panel has a small aperture ratio.

In order to solve the above problem, the technical solutions provided by the present disclosure are as follows.

The present disclosure proposes a display panel including a plurality of repeating units arranged along a first direction and a second direction, and each of the repeating units includes:
a first sub-pixel, the first sub-pixel includes a first light-transmitting area and a first non-light-transmitting area, and a first transistor is disposed in the first non-light-transmitting area; and
a second sub-pixel disposed adjacently to the first sub-pixel, the second sub-pixel includes a second transistor, and the second transistor is disposed in the first non-light-transmitting area;
the display panel further includes a plurality of spacer structures corresponding to the repeating units, and each of the spacer structures is disposed in the first non-light-transmitting area.

The present disclosure further proposes a display device including a display panel, the display panel includes a plurality of repeating units arranged along a first direction and a second direction, and each of the repeating units include:
a first sub-pixel, the first sub-pixel includes a first light-transmitting area and a first non-light-transmitting area, and a first transistor is disposed in the first non-light-transmitting area; and
a second sub-pixel disposed adjacently to the first sub-pixel, the second sub-pixel includes a second transistor, and the second transistor is disposed in the first non-light-transmitting area;
the display panel further includes a plurality of spacer structures corresponding to the repeating units, and each of the spacer structures is disposed within the first non-light-transmitting area.

### BRIEF DESCRIPTION OF THE DRAWINGS

FIG. 1 is a schematic diagram of a first structure of a display panel according to some embodiments of the present disclosure;

FIG. 2 is a schematic diagram of a second structure of a display panel according to some embodiments of the present disclosure;

FIG. 3 is a schematic cross-sectional diagram of a display panel according to some embodiments of the present disclosure;

FIG. 4 is a schematic diagram of a first structure of an array substrate in a display panel according to some embodiments of the present disclosure;

FIG. 5 is a schematic diagram of a second structure of an array substrate in a display panel according to some embodiments of the present disclosure;

FIG. 6 is a schematic diagram of a third structure of a display panel according to some embodiments of the present disclosure;

FIG. 7 is a schematic diagram of a fourth structure of a display panel according to some embodiments of the present disclosure;

FIG. 8 is a schematic diagram of a fifth structure of a display panel according to some embodiments of the present disclosure;

FIG. 9 is a schematic diagram of a structure of a light shielding layer in a display panel according to some embodiments of the present disclosure.

### DETAILED DESCRIPTION

The technical solutions in the embodiments of the present disclosure will be clearly and completely described below with reference to the accompanying drawings in the embodiments of the present disclosure. It is apparent that the embodiments described herein are only part of the embodiments of the present disclosure, but not all the embodiments of the present disclosure. Based on the embodiments in the present disclosure, all other embodiments obtained by those skilled in the art without making creative efforts fall within the scope of protection of the present disclosure. In addition, it should be understood that the specific embodiments described herein are only intended to illustrate and explain the present disclosure, and are not intended to limit the present disclosure.

In the description of the present disclosure, it should be understood that the orientation or positional relationship indicated by terms such as “length”, “width”, “thickness”, “upper”, “lower”, “front”, “back”, “left”, “right”, “top”, “bottom”, “inside”, “outside” is based on the orientation or positional relationship shown in the accompanying drawings. It is only for the convenience of describing the present disclosure and simplifying the description, and it does not indicate or imply that the device or element referred to must have a specific orientation, be constructed and operated in a specific orientation, therefore, it should not be interpreted as limitations of the present disclosure.

In addition, the terms “first” and “second” are only used for descriptive purposes, and cannot be interpreted as indicating or implying the relative importance or implicitly indicating the quantity of indicated technical features. Therefore, the features defined as the “first” and “second” may explicitly or implicitly include one or more features. In the description of the present disclosure, “a plurality of” means two or more than two, and at least one means one, two, or more than two, unless otherwise clearly and specifically limited.

Referring to FIG. 1 to FIG. 9, the present disclosure proposes a display panel 100, the display panel includes a plurality of repeating units RU arranged along a first direction X and a second direction Y. Each of the repeating units RU includes a first sub-pixel 10 and a second sub-pixel 20, and the first sub-pixel is disposed adjacently to the first sub-pixel 10.

In some embodiments, the first sub-pixel 10 includes a first light-transmitting area 110 and a first non-light-transmitting area 120. A first transistor T1 is disposed in the first non-light-transmitting area 120; the second sub-pixel 20 includes a second transistor T2, and the second transistor T2 is disposed in the first non-light-transmitting area 120.

In some embodiments, the display panel 100 further includes a plurality of spacer structures 30 corresponding to the repeating units RU, and each of the spacer structures 30 is only disposed in the first non-light-transmitting area 120.

In the present disclosure, two thin film transistors in the repeating unit RU and at least one spacer structure 30 corresponding to the repeating unit RU are all disposed in the first non-light-transmitting area 120, so that only one non-light-transmitting area is provided in the repeating unit RU, thereby increasing the area of light-transmitting area in the repeating unit RU, and improving the pixel aperture ratio of the display panel 100.

It should be noted that the second sub-pixel 20 can include a second light-transmitting area 210, the second sub-pixel 20 is not provided with a non-light-transmitting area, and the transistor of the second sub-pixel 20 is disposed in the first non-light-transmitting area 120. Therefore, in the present disclosure, it is equivalent to integrating two adjacent non-light-transmitting areas into one non-light-transmitting area, thereby increasing the overall pixel aperture ratio of the display panel 100.

It should be noted that the angle between the first direction X and the second direction Y in the present disclosure may be greater than 0 degrees and less than or equal to 90 degrees. For example, when the lateral direction is the first direction X, the longitudinal direction is the second direction Y, then the angle between the first direction X and the second direction Y can be 90 degrees.

It should be noted that the first sub-pixel 10 and the second sub-pixel 20 in the present disclosure can be arranged along the first direction X.

It should be noted that the emitting color of each of the first sub-pixel 10 and the second sub-pixel 20 of the present disclosure can be one of red, green, and blue which are different from each other. For example, the repeating unit RU may include a red sub-pixel and a green sub-pixel, or the repeating unit RU may include a green sub-pixel and a blue sub-pixel, or the repeating unit RU may include a blue sub-pixel and a red sub-pixel.

The technical solutions of the present disclosure will now be described with reference to specific embodiments.

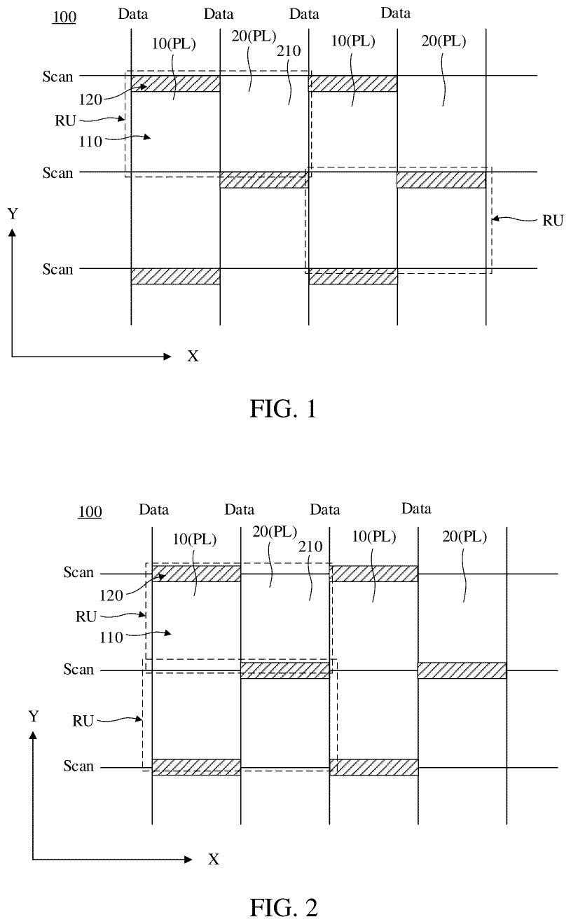

Referring to FIG. 1 and FIG. 2, the display panel 100 includes a plurality of data lines Data and a plurality of scan lines Scan. The plurality of data lines Data and the plurality of scan lines Scan are enclosed to form a plurality of sub-pixels PL. The plurality of sub-pixels PL can include a plurality of repeating units RU. A plurality of repeating units RU can be arranged along the first direction X and the second direction Y, and each of the repeating units RU is provided with a first sub-pixel 10 and a second sub-pixel 20. Meanwhile, in the structures of FIG. 1 and FIG. 2, the first non-light-transmitting areas 120 are arranged in a staggered manner along the first direction X and the second direction Y.

For example, in the structure of FIG. 1, a plurality of sub-pixels PL are arranged in an array, and the area of each of the sub-pixels PL is the same. That is, the area of the first sub-pixel 10 is the same as the area of the second sub-pixel 20, and meanwhile, the area of the second light-transmitting area 210 can be greater than the area of the first light-transmitting area 110. In FIG. 1, the transistor of the second sub-pixel 20 is disposed in the first non-light-transmitting area 120 of the first sub-pixel 10, and the spacer structure 30 corresponding to the first sub-pixel 10 and the second sub-pixel 20 is disposed in the first non-light-transmitting area 120, which is equivalent to removing the non-light-transmitting area of the second sub-pixel 20, thereby increasing the pixel aperture ratio of the second sub-pixel 20. While the area of the first non-light-transmitting area 120 in the first sub-pixel 10 is not increased, that is, the pixel aperture ratio of the first sub-pixel 10 remains unchanged, thereby increasing the pixel aperture ratio of the display panel 100.

In the structure of FIG. 1, since the emitting colors of the first sub-pixel 10 and the second sub-pixel 20 are different, it is equivalent to that the first sub-pixel 10 and the second sub-pixel 20 have different light-emitting areas, which may result in technical problem of color shift. Referring to FIG. 2, a plurality of repeating units RU are arranged in a staggered manner. The area of the first sub-pixel 10 in each of the repeating units RU is greater than the area of the second sub-pixel 20, and the area of the second light-transmitting area 210 is the same as the area of the first light-transmitting area 110.

In the structure of FIG. 2, in order to improve the color shift problem, in the present disclosure, the area of the first light-transmitting area 110 of the first sub-pixel 10 is the same as the area of the second light-transmitting area 210 of the second sub-pixel 20. Since the first sub-pixel 10 further includes the first non-light-transmitting area 120, the area of the first sub-pixel 10 is different from the area of the second sub-pixel 20. Compared with the structure in FIG. 1, it is equivalent that a part of the first non-light-transmitting area 120 is moved upward into adjacent sub-pixel PL along the second direction Y, which is equivalent to increasing the area of the first light-transmitting area 110, and at the same time, the area of the second light-transmitting area 210 is increased to be the same as the area of the first light-transmitting area 110. In some embodiments, the area of the part of the first light-transmitting area 110 moving upward can be half of the area of the first non-light-transmitting area 120, so that the increased area of each of the first light-transmitting area 110 and the second light-transmitting area 210 is equivalent to half of the area of the first non-light-transmitting area 120.

Compared with the structure in FIG. 1, the area of the first sub-pixel 10 and the area of the first light-transmitting area 110 of the present disclosure are both increased, and the pixel aperture ratio of the first sub-pixel 10 is increased. The area of the second sub-pixel 20 is reduced, and the area of the second light-transmitting area 210 is increased, therefore, the pixel aperture ratio of the second sub-pixel 20 is increased, thereby increasing the pixel aperture ratio of the display panel 100.

It should be noted that, for convenience of description, the structures of the repeating units RU in FIG. 2 are irregular structures. For example, along the first direction X, in two adjacent repeating units RU, the first sub-pixel 10 of one of the two adjacent repeating units RU is disposed adjacently to the second sub-pixel 20 of the other one of the two adjacent repeating units RU. Along the second direction Y, the first sub-pixel 10 of one of the two adjacent repeating units RU is arranged adjacently to the second sub-pixel 20 of the other one of the two adjacent repeating units RU.

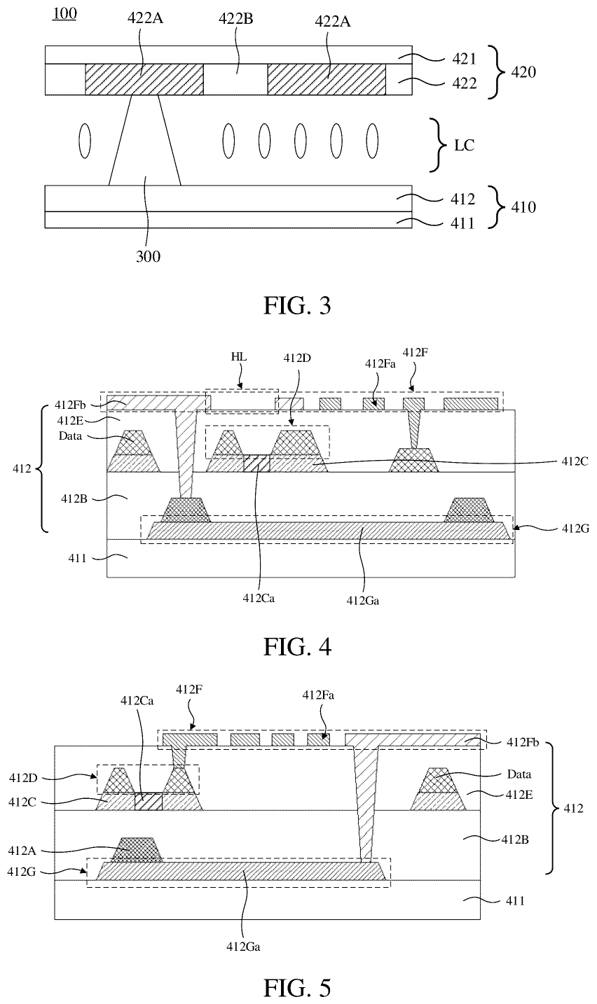

Referring to FIG. 3, the display panel 100 may include an array substrate 410 and a color filter substrate 420. The array substrate 410 and the color filter substrate 420 are disposed oppositely. A liquid crystal layer LC is further disposed between the array substrate 410 and the color filter substrate 420. The array substrate 410 can be a conventional array substrate 410 or a color filter on array (COA for short, that is, the color filter layer 422 is disposed on the substrate) substrate. In the following embodiments, the array substrate 410 being a conventional array substrate 410 is taken as an example for explanation.

Referring to FIG. 3, the array substrate 410 may include a first substrate 411 and an array layer 412 located on the first substrate 411. The first substrate 411 may be made of materials such as glass, quartz, polyimide.

In some embodiments, the array layer 412 may include a plurality of thin film transistors. The thin film transistors may be of an etch-stop type or a back-channel-etching type, or may be divided into structures such as bottom-gate thin film transistor, top-gate thin film transistor according to the positions of the gate and the active layer 412C. For example, the thin film transistor of the bottom-gate thin film transistor type may include a gate layer 412A located on the first substrate 411, a gate insulation layer 412B located on the gate layer 412A, the active layer 412C located on the gate insulation layer 412B, a source and drain layer 412D located on the active layer 412C, a flat layer 412E located on the source and drain layer 412D, a second electrode layer 412F located on the flat layer 412E, and a first electrode layer 412G located on one side of the second electrode layer 412F.

In some embodiments, the first electrode layer 412G is disposed between the second electrode layer 412F and the first substrate 411. For example, in the structures of FIG. 4 and FIG. 5, the first electrode layer 412G can be disposed between the gate layer 412A and the first substrate 411. The first electrode layer 412G may include a common electrode, the second electrode layer 412F may include a pixel electrode 412Fa, and the electric field formed by the common electrode 412Ga and the pixel electrode 412Fa drives the liquid crystal molecules in the liquid crystal layer LC to deflect.

In some embodiments, the color filter substrate 420 may include a second substrate 421 and a color filter layer 422 located on the second substrate 421. The color filter layer 422 includes a light-shielding layer 422A and a plurality of color resistance units 422B with different colors.

Referring to FIG. 2 and FIG. 3, the display panel 100 may further include a spacer layer disposed between the array substrate 410 and the color filter substrate 420. The spacer layer includes a plurality of spacer pillars. A spacer structure 30 may include at least one spacer pillar.

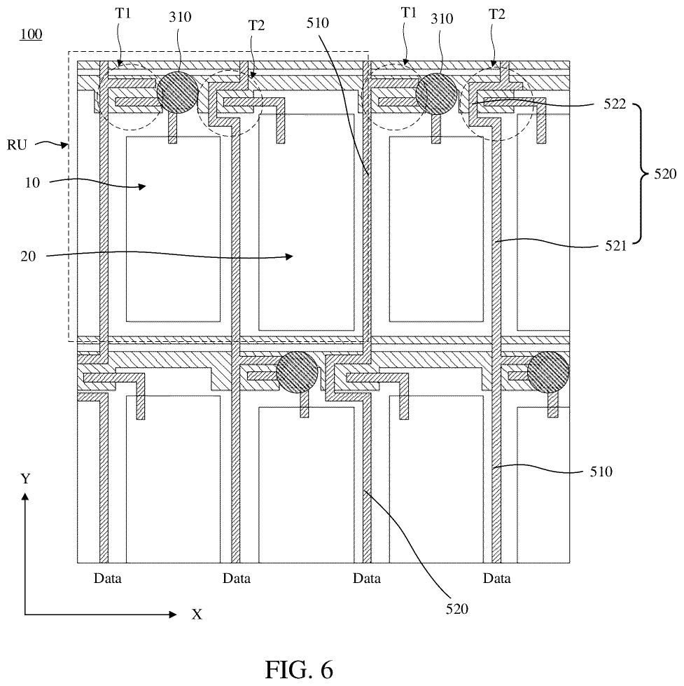

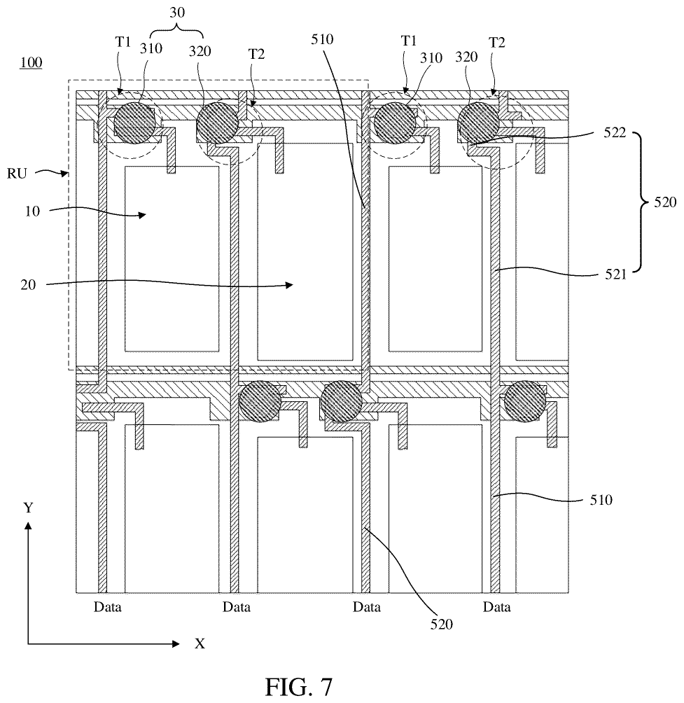

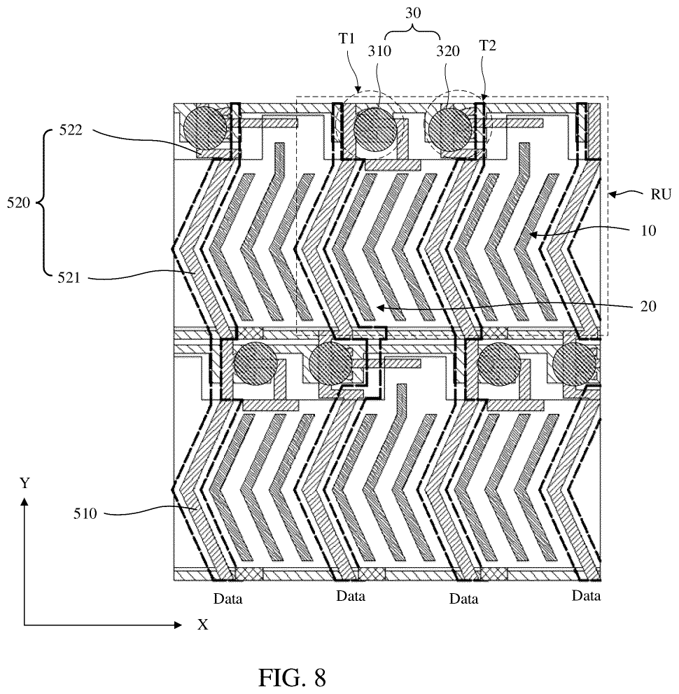

In some embodiments, referring to FIG. 6, one spacer pillar is disposed in a sub-pixel PL, and the spacer pillar is located in the non-light-transmitting area corresponding to the sub-pixel PL. In the structures of FIG. 7 and FIG. 8, a spacer structure 30 may include two spacer pillars, and the two spacer pillars are all located in the non-light-transmitting area of a sub-pixel PL in the repeating unit RU. For example, in the structures of FIG. 7 and FIG. 8, the spacer structure 30 may include a first spacer pillar 310 and a second spacer pillar 320, and each of the first spacer pillar 310 and the second spacer pillar 320 can be disposed in the first non-light-transmitting area 120 of the first sub-pixel 10.

In some embodiments, the spacer pillars are generally made of organic materials and the light transmittance thereof cannot reach 100%. Therefore, in the present disclosure, the spacer pillars corresponding to two adjacent sub-pixels PL in the same repeating unit RU are disposed in the non-transparent area in one sub-pixel PL, thereby increasing the pixel aperture ratio of the second sub-pixel 20, and while the pixel aperture ratio of the first sub-pixel 10 remains unchanged or is increased, thereby increasing the overall pixel aperture ratio of the display panel 100.

In the display panel 100 of the present disclosure, the display panel 100 includes at least one first data segment 510 and at least one second data segment 520 that are disposed oppositely. The first data segment 510 is disposed on the side of the first sub-pixel 10 away from the second sub-pixel 20. The first data segment 510 is connected to the first sub-pixel 10, and the second data segment 520 is connected to the second sub-pixel 20.

Referring to FIG. 6 and FIG. 7, each of the data lines Data can include a plurality of first data segments 510 and a plurality of second data segments 520 that are spaced apart, and the first data segment 510 and the second data segment 520 adjacent to each other are electrically connected. For the first data segment 510 and the second data segment 520 of the same data line Data, the first data segment 510 is connected to the first sub-pixel 10 of one repeating unit RU, and the second data segment 520 is connected to the second sub-pixel 20 of another repeating unit RU. That is, in the same repeating unit RU, the first data segment 510 connected to the first sub-pixel 10 and the second data segment 520 connected to the second sub-pixel 20 belong to parts of different data lines Data.

It should be noted that the first sub-pixel 10 is connected to the first data segment 510, that is, the first transistor T1 in the first sub-pixel 10 is connected to the first data segment 510, and the second sub-pixel 20 is connected to the second data segment 520, that is, the second transistor T2 in the second sub-pixel 20 is connected to the second data segment 520.

In the structures of FIG. 7 and FIG. 8, the spacer structure 30 includes a first spacer pillar 310 and a second spacer pillar 320. Each of the first spacer pillar 310 and the second spacer pillar 320 is disposed between the first data segment 510 and the second data segment 520, and the first data segment 510 and the second data segment 520 respectively belong to the data segment of two data lines Data adjacent to each other.

In some embodiments, since the first non-light-transmitting area 120 and the first light-transmitting area 110 in the first sub-pixel 10 are arranged along the second direction Y, in order to avoid an increase of the area of the first non-light-transmitting area 120, the first spacer pillar 310 and the second spacer pillar 320 of the present disclosure are arranged along the first direction X, the first spacer pillar 310 is disposed close to the first data segment 510, and the second spacer pillar 320 is disposed close to the second data segment 520.

In some embodiments, since the spacer pillars are mainly configured to adjust the cell spacing between the array substrate 410 and the color filter substrate 420, the spacer pillars are generally evenly distributed between the array substrate 410 and the color filter substrate 420. In the present disclosure, the second spacer pillar 320 originally located in the second sub-pixel 20 is moved to the first sub-pixel 10, resulting in that no spacer pillar is provided in the area where the second sub-pixel 20 is located, which in turn leads to differences in the cell spacing in different areas. Therefore, in the present disclosure, the first spacer pillar 310 can be disposed close to the first data segment 510, and the second spacer pillar 320 can be disposed close to the second data segment 520, thereby alleviating the technical problem of differences in cell spacing in different areas.

For example, in the first direction X, the distance between the first spacer pillar 310 and the second spacer pillar 320 is greater than the distance between the first spacer pillar 310 and the first data segment 510, and the distance between the first spacer pillar 310 and the second spacer pillar 320 is greater than the distance between the second spacer pillar 320 and the second data segment 520. That is, each of the first spacer pillar 310 and the second spacer pillar 320 of the present disclosure can deviate toward the corresponding data segment respectively, thereby alleviating the technical problem of differences in cell spacing in different areas.

In some embodiments, in the light emitting direction of the display panel 100, the first transistor T1 at least partially overlaps the first spacer pillar 310, and the second transistor T2 at least partially overlaps the second spacer pillar 320.

Referring to FIG. 7 and FIG. 8, the second data segment 520 includes an extending segment 521 and a bending segment 522 connected to each other. The extending segment 521 is disposed between the first sub-pixel 10 and the second sub-pixel 20, and the bending segment 522 is located in the non-light-transmitting area 120.

In some embodiments, since each of the data lines Data extends along the second direction Y, when the second transistor T2 is disposed in the first non-light-transmitting area 120, at least part of the second data segment 520 connected to the second transistor T2 needs to be bent toward the first sub-pixel 10. For example, in the structures of FIG. 7 and FIG. 8, the second data segment 520 includes an extending segment 521 and a bending segment 522 connected to each other. The arrangement of the bending segment 522 makes the second transistor T2 deviate toward the first sub-pixel 10 and enables the second transistor T2 to be located in the first non-light-transmitting area 120, which increases the pixel aperture ratio of the second sub-pixel 20, and while the pixel aperture ratio of the first sub-pixel 10 remains unchanged or is increased, thereby improving the overall pixel aperture ratio of the display panel 100.

In this embodiment, the spacer structure 30 includes the first spacer pillar 310, and the first spacer pillar 310 is disposed between the first data segment 510 and the second data segment 520. For example, referring to FIG. 6, each of the repeating units RU can be provided with only one first spacer pillar 310, and the distance between the center of the first spacer pillar 310 and the first data segment 510 in the first direction is the same as the distance between the center of the first spacer pillar 310 and the second data segment 520 in the first direction X.

Similarly, in the case where the size of the spacer pillar is matched with the area of the first non-light-transmitting area 120, the spacer structure 30 may further include three or more spacer pillars, and which is not limited in the present disclosure.

In the display panel 100 of the present disclosure, referring to FIG. 4 and FIG. 5, the second electrode layer 412F may further include a shielding electrode 412Fb. The shielding electrode 412Fb is electrically connected to the common electrode, and the orthographic projection of the first data segment 510 or the second data segment 520 on the second electrode layer 412F is within the shielding electrode 412Fb.

For example, in the structure of FIG. 4, it can be the structure of the first transistor T1 of the present disclosure. Since the first data segment 510 is disposed on the left side of the first transistor T1, the shielding electrode 412Fb of the present disclosure can be disposed on the left side of the first transistor T1. The orthographic projection of the first data segment 510 on the second electrode layer 412F is in the shielding electrode 412Fb. The shielding electrode 412Fb is provided with a constant voltage, and the arrangement of the shielding electrode 412Fb provides a shielding effect on the first data segment 510, thereby avoiding the impact of the voltage conversion of the first data segment 510 on the deflection of the liquid crystal, and ensuring the normal deflection of the liquid crystal corresponding to the data line Data. At the same time, the impact of the voltage conversion of the first data segment 510 on the voltage of the pixel electrode 412Fa in the second sub-pixel 20 in another repeating unit RU adjacent to the first data segment 510 is also avoided, and the stability of the pixel voltage is ensured.

For example, in the structure of FIG. 5, the structure can be the structure of the first transistor T1 of the present disclosure. Since the second data segment 520 is disposed on the right side of the first transistor T1, the shielding electrode 412Fb of the present disclosure can be disposed on the right side of the first transistor T1. The orthographic projection of the second data segment 520 on the second electrode layer 412F is in the shielding electrode 412Fb. The shielding electrode 412Fb is provided with a constant voltage, and the arrangement of the shielding electrode 412Fb provides a shielding effect on the second data segment 520, thereby ensuring the normal deflection of the liquid crystal corresponding to the data line Data. At the same time, the stability of the voltage of the pixel electrode 412Fa in the second sub-pixel 20 in the same repeating unit RU is ensured.

It should be noted that the structures of FIG. 4 and FIG. 5 can be combined in the same embodiment, that is, the orthographic projection of each of the first data segment 510 and the second data segment 520 respectively connected to one of two transistors in the same repeating unit RU on the second electrode layer 412F is in the shielding electrode 412Fb.

In the structure of FIG. 4, the display panel 100 further includes an active layer 412C disposed between the first electrode layer 412G and the second electrode layer 412F, and the active layer 412C includes a channel portion 412Ca. The shielding electrode 412Fb is further provided with a through hole HL, and the orthographic projection of the channel portion 412Ca on the shielding electrode 412Fb is in the through hole HL.

In some embodiments, since a constant voltage is provided on the shielding electrode 412Fb, and when the shielding electrode 412Fb is overlapped with the channel portion, the voltage on the shielding electrode 412Fb will cause the channel portion 412Ca to conduct. Therefore, the shielding electrode 412Fb disposed on the transistor in the present disclosure needs to be arranged to avoid the channel portion 412Ca.

It should be noted that since the shield electrode 412Fb is only arranged to avoid the channel portion 412Ca, the voltage on the shielding electrode 412Fb will also affect the conduction of the channel portion 412Ca. Therefore, in the present disclosure, the orthographic projection of the channel portion 412Ca on the shielding electrode 412Fb can be in the through hole HL, or the orthographic projection of the first transistor and/or the second transistor on the shielding electrode 412Fb can be in the through hole HL.

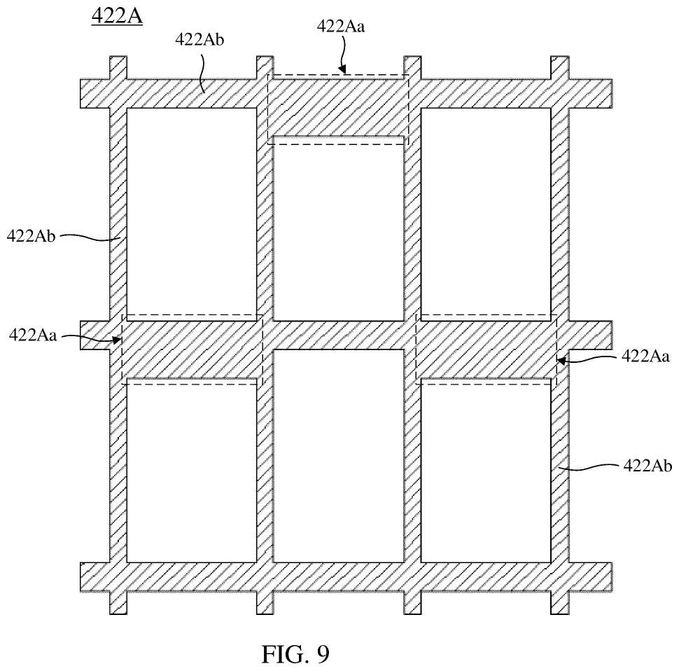

Referring to FIG. 9, the light-shielding layer 422A includes a plurality of light-shielding units 422Aa and light-shielding strips 422Ab connecting every two adjacent light-shielding units 422Aa, and the light-shielding layer 422A is in a meshed structure. One light-shielding unit 422Aa corresponds to one repeating unit RU, and the orthographic projection of the first non-light-transmitting area 120 on the light-shielding layer 422A is in the corresponding light-shielding unit 422Aa.

In some embodiments, one light-shielding unit 422Aa corresponds to one first non-light-transmitting area 120 and fully covers the first non-light-transmitting area 120. At the same time, the light-shielding strip between two adjacent light-shielding units 422Aa covers the data line Data and the scan line Scan in the display panel 100.

It should be noted that the embodiments of the present disclosure are applicable to structures of different types of sub-pixel PL, for example, the two different sub-pixel PL structures in FIG. 6 to FIG. 8, which are not specifically limited in the present disclosure.

It should be noted that liquid crystal molecules are disposed under a part of the light-shielding layer 422A in FIG. 3, which is only for illustrating that the color resistance units 422B are disposed between the meshed structure formed by the light-shielding layer 422A. That is, FIG. 3 is only a schematic diagram of the present disclosure, and it does not represent the final structure of the display panel of the present disclosure.

The present disclosure further proposes a display device, and the display device includes the display panel described above. The display device can be any product or component with a display function, such as a mobile phone, a tablet computer, a television, a monitor, a notebook computer, a digital photo frame, a navigator, and the like.

In the above embodiments, each embodiment is described with its own emphasis. For parts that are not described in detail in a certain embodiment, reference can be made to the relevant descriptions of other embodiments.

The embodiments of the present disclosure have been introduced in detail above. Specific examples are used herein to illustrate the principles and implementations of the present disclosure, and the above description of the embodiments is merely intended to help understand the technical solution and its core idea of the present disclosure. Those skilled in the art should understand that: it is still possible to modify the technical solutions recorded in the above embodiments, or to equivalently replace part of the technical features thereof. However, these modifications or replacements do not cause the essence of the corresponding technical solutions to depart from the scope of the technical solutions of the embodiments of the present disclosure.

What is claimed is:

1. A display panel comprising a plurality of repeating units arranged along a first direction and a second direction, wherein each of the repeating units comprises:
a first sub-pixel, wherein the first sub-pixel comprises a first light-transmitting area and a first non-light-transmitting area, and a first transistor is disposed in the first non-light-transmitting area; and
a second sub-pixel disposed adjacently to the first sub-pixel, wherein the second sub-pixel comprises a second transistor, and the second transistor is disposed in the first non-light-transmitting area;
wherein the display panel further comprises a plurality of spacer structures corresponding to the repeating units, and each of the spacer structures is only disposed in the first non-light-transmitting area.

2. The display panel according to claim 1, wherein the display panel comprises at least one first data segment and at least one second data segment disposed oppositely, the first data segment is disposed on a side of the first sub-pixel away from the second sub-pixel, the first data segment is connected to the first sub-pixel, and the second data segment is connected to the second sub-pixel.

3. The display panel according to claim 2, wherein the second data segment comprises an extending segment and a bending segment connected to each other, the extending segment is disposed between the first sub-pixel and the second sub-pixel, and the bending segment is located in the first non-light-transmitting area.

4. The display panel according to claim 3, wherein each of the spacer structures comprises a first spacer pillar and a second spacer pillar, and each of the first spacer pillar and the second spacer pillar is disposed between the first data segment and the second data segment;
wherein the first spacer pillar and the second spacer pillar are arranged along the first direction, the first spacer pillar is disposed close to the first data segment, the second spacer pillar is disposed close to the second data segment, in a light emitting direction of the display panel, the first transistor at least partially overlaps the first spacer pillar, and the second transistor at least partially overlaps the second spacer pillar.

5. The display panel according to claim 4, wherein in the first direction, a distance between the first spacer pillar and the second spacer pillar is greater than a distance between the first spacer pillar and the first data segment, and the distance between the first spacer pillar and the second spacer pillar is greater than a distance between the second spacer pillar and the second data segment.

6. The display panel according to claim 3, wherein each of the spacer structures comprises a first spacer pillar, and the first spacer pillar is disposed between the first data segment and the second data segment;
wherein a distance between a center of the first spacer pillar and the first data segment in the first direction is same as a distance between the center of the first spacer pillar and the second data segment in the first direction.

7. The display panel according to claim 3, wherein each of the spacer structures comprises a first spacer pillar and a second spacer pillar, and each of the first spacer pillar and the second spacer pillar is disposed in the first non-light-transmitting area of the first sub-pixel.

8. The display panel according to claim 3, wherein the display panel further comprises:
a first substrate;
a first electrode layer disposed on a side of the first substrate, wherein the first electrode layer comprises a common electrode; and
a second electrode layer disposed on a side of the first electrode layer away from the first substrate, wherein the second electrode layer comprises a pixel electrode and a shielding electrode, and the shielding electrode is electrically connected to the common electrode;
wherein an orthographic projection of the first data segment or/and the second data segment on the second electrode layer is in the shielding electrode.

9. The display panel according to claim 8, wherein the display panel further comprises an active layer disposed between the first electrode layer and the second electrode layer, the active layer comprises a channel portion, the shielding electrode is further provided with a through hole, and an orthographic projection of the channel portion on the shielding electrode is in the through hole.

10. The display panel according to claim 2, wherein the display panel comprises a plurality of data lines, each of the data lines comprises a plurality of the first data segments and a plurality of the second data segments that are spaced apart, a first data segment of the first data segments and a second data segment of the second data segments adjacent to each other are electrically connected, for the first data segment and the second data segment of a same data line, the first data segment is connected to a first sub-pixel of one repeating unit, and the second data segment is connected to a second sub-pixel of another repeating unit.

11. The display panel according to claim 1, wherein the display panel further comprises a light-shielding layer, the light-shielding layer comprises a plurality of light-shielding units, one of the light-shielding units corresponds to one of the repeating units, and an orthographic projection of the first non-light-transmitting area on the light-shielding layer is located in a corresponding one of the light-shielding units.

12. The display panel according to claim 11, the light-shielding layer further comprises a light-shielding strip connecting two adjacent ones of the light-shielding units, and the light-shielding layer is in a meshed structure.

13. The display panel according to claim 1, wherein an area of the first sub-pixel is same as an area of the second sub-pixel;
wherein the second sub-pixel comprises a second light-transmitting area, and an area of the second light-transmitting area is greater than an area of the first light-transmitting area.

14. The display panel according to claim 1, wherein an area of the first sub-pixel is greater than an area of the second sub-pixel;
wherein the second sub-pixel comprises a second light-transmitting area, and an area of the second light-transmitting area is same as an area of the first light-transmitting area.

15. The display panel according to claim 1, wherein an emitting color of each of the first sub-pixel and the second sub-pixel is one of red, green and blue that are different from each other.

16. A display device comprising a display panel, wherein the display panel comprises a plurality of repeating units arranged along a first direction and a second direction, and each of the repeating units comprises:
a first sub-pixel, wherein the first sub-pixel comprises a first light-transmitting area and a first non-light-transmitting area, and a first transistor is disposed in the first non-light-transmitting area; and
a second sub-pixel disposed adjacently to the first sub-pixel, wherein the second sub-pixel comprises a second transistor, and the second transistor is disposed in the first non-light-transmitting area;
wherein the display panel further comprises a plurality of spacer structures corresponding to the repeating units, and each of the spacer structures is only disposed in the first non-light-transmitting area.

17. The display device according to claim 16, wherein the display panel comprises at least one first data segment and at least one second data segment disposed oppositely, the first data segment is disposed on a side of the first sub-pixel away from the second sub-pixel, the first data segment is connected to the first sub-pixel, and the second data segment is connected to the second sub-pixel.

18. The display device according to claim 17, wherein the second data segment comprises an extending segment and a bending segment connected to each other, the extending segment is disposed between the first sub-pixel and the second sub-pixel, and the bending segment is located in the first non-light-transmitting area.

19. The display device according to claim 18, wherein each of the spacer structures comprises a first spacer pillar and a second spacer pillar, and each of the first spacer pillar and the second spacer pillar is disposed between the first data segment and the second data segment;
wherein the first spacer pillar and the second spacer pillar are arranged along the first direction, the first spacer pillar is disposed close to the first data segment, the second spacer pillar is disposed close to the second data segment, in a light emitting direction of the display panel, the first transistor at least partially overlaps the first spacer pillar, and the second transistor at least partially overlaps the second spacer pillar.

20. The display device according to claim 19, wherein in the first direction, a distance between the first spacer pillar and the second spacer pillar is greater than a distance between the first spacer pillar and the first data segment, and the distance between the first spacer pillar and the second spacer pillar is greater than a distance between the second spacer pillar and the second data segment.
